(19) United States
(12) Patent Application Publication
(10) Pub. No.: US 2010/0036744 A1
(43) Pub. Date: Feb. 11, 2010

(54) METHOD FOR FACILITATING THE GLOBAL DONATION OF ITEMS AND SERVICES

(76) Inventor: Sion L. Tesone, Miami Beach, FL (US)

Correspondence Address: LOTT & FRIEDLAND, P.A., P.O. BOX 141098, CORAL GABLES, FL, 33114-1098, US

(21) Appl. No.: 12/186,401

(22) Filed: Aug. 5, 2008

(51) Int. Cl. G06Q 30/00

(52) U.S. Cl. 705/26

(57) ABSTRACT

The present invention is a method and system for facilitating the global donation of items and services from a donor located anywhere in the world to a recipient with specific characteristics located anywhere in the world that substantially matches the desired criteria of the donor whereby the interface between the donor and the recipient is an Internet portal or website. The objective of the method and system is to empower the donors and to ensure that donations reach those that the donor had intended more efficiently and directly in comparison to the types of charitable organizations and government run programs that currently exist.

### FIELD OF THE INVENTION

The present invention relates to a method and system for empowering an individual donor to donate an item or service in a highly efficient and direct manner to a recipient having a specific set of characteristics as defined by the donor in a global donation scheme using an Internet portal or website.

### BACKGROUND OF THE INVENTION

Currently, there exist a large and overwhelming number of individuals around the world who live in an environment of poverty and destitution and do not have the means to foster any hope for change. This type of condition can be seen everywhere, but it is particularly prevalent in war-stricken areas, third world countries, and the urban areas of large cities. Fortunately, the world is also abundant with individuals and organizations that are highly motivated to contribute to the livelihood of those who are less fortunate than themselves through the donation of items and services. As a result, a variety of non-profit and for profit governmental and charitable organizations and programs have been established in a collaborative effort to meet the needs of people in all corners of the globe, which is oftentimes a difficult logistical challenge for the individual donor. A number of these organizations have since developed a meaningful and prestigious history. However, despite these efforts, a lack of confidence by the general public has arisen with respect to these organizations as many of the organizations suffer from bureaucratic backlog, corruption, poor accounting practices, lack of funding and mass disorganization that leads to waste and inefficiency. Unfortunately, it is particularly difficult for the individual donor to bypass these organizations and to direct their donations to a desired recipient who has specific characteristics, such as the specific geographical location.

For example, suppose that a donor who is located in Dayton, Ohio (United States) would like to donate a used digital camera to a person who is located in Bogotá, Colombia. Currently, there are not any simple and reliable logistical means of making such a donation and the donor is limited by the geographical reach and capabilities of the existing charitable organizations. Additionally, the existing organizations do not advise the donor as to whether their donation has reached the person or destination that the donor had in mind. Even in instances where the donor can donate to a specific cause, the donor is not provided with any assurance or confirmation that the donation has been properly routed to the intended recipient or is being used in the way that the donor had envisioned.

Therefore, an object of the present invention is to provide a method and system that empowers any individual to directly donate items or services to any person with a set of specific characteristics and geographical location without having to send the donation through an existing charitable organization. With the advent of the Internet and the support of a certified group of already existing local organizations, this type of method and system is made possible.

In addition, many of the large charitable organizations and entities typically do not take into account the individual, highly selective needs and desires of their identified recipients. Ordinarily, these organizations and programs only focus on items and services in bulk that take care of the most basic human needs such as food, shelter, wearable clothing, and minimal health supplies and services. Due to the shortages in donations in comparison to the number of those in need, these organizations are often welcoming of any type of aid and choose to prioritize providing for basic needs rather than specific items or services. Although some organizations seek donations of specific items in some instances, e.g. presents for underprivileged or ill children during certain holidays or for abused women who are trying to enter the workforce with the proper attire, etc., currently there are no organizations that empower the recipient to receive what he or she would most want and that empower the donor to donate an item or service to a person with a set of particular specifications anywhere in the world that the donor would most want to donate to. In most instances, those in need are overwhelmingly satisfied by receiving any type of gift from a donor. However, it would be most beneficial to provide a method and system of donation in which a donor and a recipient can indicate, with a high degree of specificity, the type of item and desired characteristics of the recipient that the donor wishes to donate to and the type of item that the recipient would like to receive.

Therefore, another object of the present invention is to provide a method and system for facilitating the donation of items and services that allows for donors and recipients to provide a detailed description of the subject item or service wherein the method and system match a particular donor to a particular recipient based upon the subject item or service, geographical location of the recipient, and other specific criteria established by the donor and stored in a database with the recipient's information. As a result, every item or service that is donated and thereafter received will have an actual recipient that is requesting that item or service thereby establishing a higher degree of empowerment and happiness for both the donor and the recipient. Thus, resources are not wasted and a recipient's specific and individual needs and desires are met efficiently.

Also, as stated above, many of the governmental and charitable organizations that currently exist do not provide a mechanism whereby the donor can hold the organization accountable for the ultimate destination (e.g. place and date received) of his or her donation. Although many of the organizations and other types of intermediaries normally provide a receipt to the donor showing an approximate amount and description of the items being donated at the time of the donation, the donor is not kept informed during the process that occurs thereafter. In order to increase the confidence of the general public in the donation process, to create a system of checks and balances that will aid in the efficacy of the donations and to provide a high level of quality control, it is desirable to create a donation method and system that allows the donor to track his or her donation from the time of donation to the time it is received by the intended recipient. Presently, there exists a variety of tracking systems that are used in the mail and freight industries for tracking the delivery of packages using, for example, radio frequency ID and barcode or other scanning technology. However, these tracking systems only provide confirmation of the time and place of receipt and do not provide assurance that the intended recipient received the item.

Therefore, another object of the present invention is to utilize the present shipment tracking systems and to further provide a transparent method of allowing the donor to track the donated item and receive a substantially full-proof confirmation that the intended recipient received the item.

Furthermore, the method and system is also intended to reduce the enormous amount of waste that is created by the discarding of used items that are still in usable condition and that others may want and find value in.

### SUMMARY OF THE INVENTION

The present invention is a method and system for facilitating the global donation of items and services from a donor located anywhere in the world to a recipient with specific characteristics located anywhere in the world that substantially matches the desired criteria of the donor whereby the interface between the donor and the recipient is an Internet portal or website. One objective of the method and system is to empower individual donors to donate to a particular recipient in a way that ensures that the donation has reached those that the donor has intended in a more efficient and direct way in comparison to the charitable organizations and government operated programs that currently exist.

On the recipient side of the donation, it is envisioned that the recipient preferably belongs to a local organization that is associated with the recipient and is certified and trained to utilize the method and system of the present invention. These local organizations serve as the bridge between the donors and the recipients. Such a bridge is needed due to the likelihood that many of the recipients will not have the necessary degree of literacy to fully utilize the method and system on their own. The local organization that is associated with the recipient will use the current method and system by means of a password protected section of the portal or website to provide information about each recipient (e.g. a picture of the recipient and/or biographical information about the recipient, such as the recipient's name, date of birth, address, etc.) and a detailed description of the items or services that each recipient wishes to receive. The system could be configured to allow the entry of only a limited number of items and/or services per recipient in a given amount of time. This information is then stored in a database and is later used to match the recipient's desired item or service to an item or service that is being donated by a donor.

On the donor side of the donation, thru another password protected section, the donor utilizes the portal or website to perform different tasks. These tasks include but are not limited to searching for a recipient with specific characteristics. This search can be performed by analyzing all of the current recipient data that has been stored and performing searches of the data in different sequences based upon geographical location, items or services that are being requested and/or specific biographical characteristics of the recipient. Also, if the donor has a particular item or service that he or she would like to donate, the donor can provide a detailed written description and/or visual description of any item or service that the donor wishes to donate. The donor can also enter specific criteria about the type of recipient that the donor wishes to donate the particular item to. By being able to search for or to define the characteristics of the recipient, the donor is empowered to choose where and to whom the donation will be received rather than having little to no control over the destination of the item or service.

Once the donor's information is entered and stored, the portal or website performs a search and provides one or more matches, using methods known to those skilled in the art, between the item or service being donated by the donor, the characteristics of the intended recipient, the characteristics of recipients that have already been entered and stored in the system and the items or services that have been requested by the recipients. The search capabilities of the portal or website will be sophisticated enough to provide alternatives to the donor when a direct match does not exist. For example, if there is more than one direct match, the portal or website will choose a recipient based upon a number of factors including the donor's desired biographical characteristics of the intended recipient, the amount of time the recipients have been waiting for a donation, and the order in which the recipients were entered into the system. If the system cannot find a direct match at all, the system will ask the donor if he or she wishes to send an alert to the local organizations that exist in the geographical location specified by the donor that asks for a potential recipient that has the desired characteristics specified by the donor.

Once a match has been provided and the item or service reaches the certified local organization associated with the recipient, the local organization finds the recipient and gives the item or service to the recipient. At that time, the local organization takes a picture of the recipient with the donated item or service. This picture, along with a confirmation receipt will be uploaded into the portal or website such that if the donor wishes to receive confirmation of the donation, the donor will receive a notification by e-mail or another form with the picture and the confirmation receipt.

With regards to the costs of shipping the donated items, the donor will receive instructions on how to arrange for and ship the item. The donor can opt to pay the full amount or a portion of the amount or may opt to not pay for the shipping costs at all. In the event that the donor does not pay for the full amount of the shipping costs, the remaining shipping costs will be paid for by other donors who have volunteered to pay for shipping costs or by the organization utilizing the method and system of the present invention. Alternatively or in conjunction, it is envisioned that partnerships will be formed with one or more well-known shipping carriers whereby the shipping carriers will agree to pay for some or all of the costs of shipping or provide discounts in their rates in return for shipping volume, free advertising or charitable tax deductions.

The method and system of the present invention derives its main source of revenue from advertising via the portal or website and this revenue will be used to run the organization, and to provide costs of shipping where needed.

All aspects of the organization utilizing the disclosed method and system, including any costs associated with the donation, will be completely transparent and accessible thru the portal or website to the donor thereby ensuring that the donation reaches the donor's target recipient and does not in any way benefit any other person or organization.

### BRIEF DESCRIPTION OF THE DRAWINGS

FIG. 1 is a diagram of a preferred embodiment of the method and system of the present invention.

FIG. 2 is a flow chart of a preferred embodiment of the present invention wherein a local certified organization, after it has been certified, accesses the portal, creates a profile and requests a donation.

FIG. 3 is a flow chart of a preferred embodiment of the present invention wherein a donor accesses the portal and creates an account or profile.

FIG. 4 is a flow chart of a preferred embodiment of the present invention wherein a donor wishes to search for a recipient with a set of specific characteristics.

FIG. 5 is a flow chart of a preferred embodiment of the present invention wherein a donor wishes to donate a particular item and/or service.

FIG. 6 is a flow chart of a preferred embodiment of the present invention wherein a donor selects a particular recipient to receive the donation and ships the item and/or service to the selected recipient.

FIG. 7 is a flow chart of a preferred embodiment of the present invention wherein the donor tracks the shipment to the recipient and receives confirmation that the recipient has received the donation.

FIG. 8 is a diagram of a preferred embodiment of the source and destination of all resources used in the method and system of the present invention.

FIG. 9 is a diagram of a preferred embodiment of how the managing organization and each certified local organization will be overseen.

### DETAILED DESCRIPTION OF THE INVENTION

In order to solve many of the problems described above that are associated with the existing methods and systems that provide for the donation of items, the present invention provides a method and system for facilitating the global donation of items and services from a donor located anywhere in the world to a recipient with specific characteristics located anywhere in the world that substantially matches the desired criteria of the donor whereby the interface between the donor and the recipient is an Internet portal or website. In essence, the method and system establish a global philanthropic community that empowers an individual donor to independently and reliably donate an item or service to anywhere in the world and to a specific recipient and ensures that the item or service reaches the recipient in a more efficient and direct manner than the methods and systems that currently exist. For a better understanding of the present invention, reference may be had to the following detailed description taken in conjunction with the appended claims and accompanying drawings.

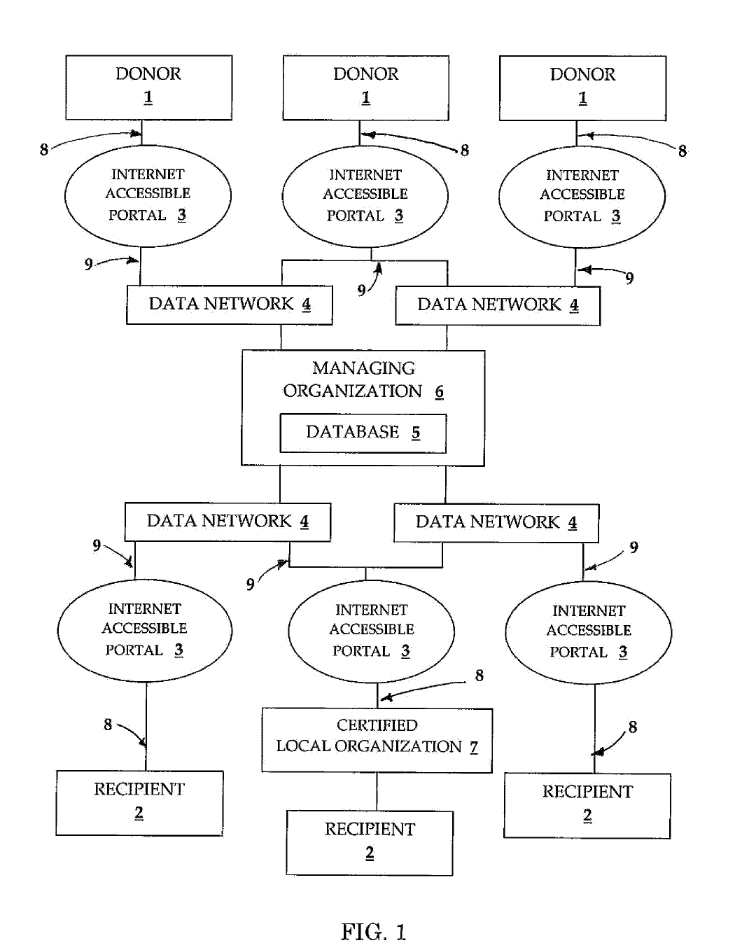

Referring to FIG. 1, a website or other portal (3) that is Internet-accessible is provided in order for each user to use the method and system of the present invention. Users of the present invention include, but are not limited to, individual, private donors, non-profit and for profit private and public charitable organizations, government supported relief and charitable organizations, individual, private recipients, and relief and charitable organizations that are associated with an individual recipient (2) thru a certified local organization (7). Each user can access the website or portal (3) using any device that is capable of connecting to the Internet, such as a personal computer or a handheld mobile device. The website or portal (3) is comprised of a user-friendly interface (8) and is in communication with one or more data networks (4) using a wired or wireless connection (9) to the one or more networks. This network connection gives the users and any local organizations access to the database (5) that is operated by a managing organization (6).

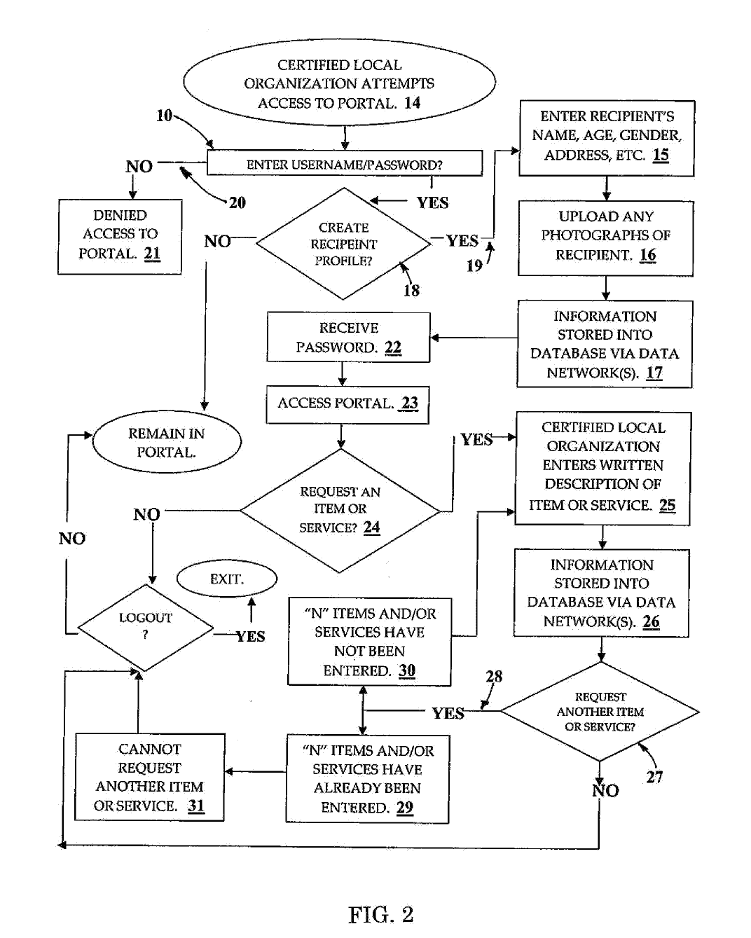

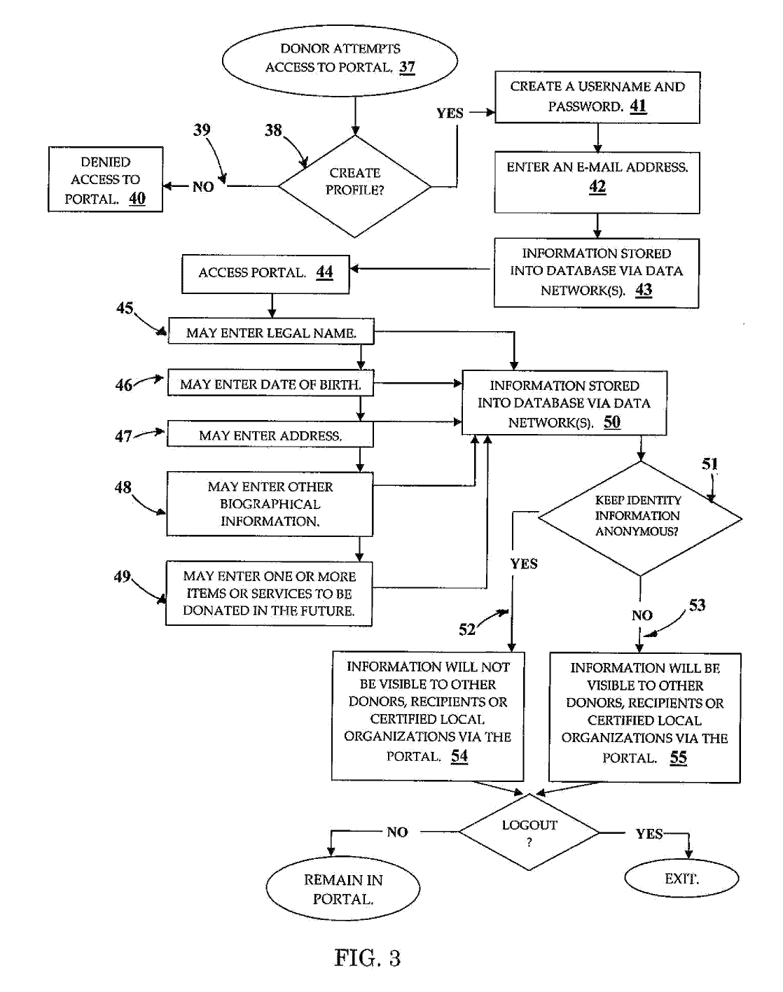

Referring to FIGS. 1, 2 and 3, in order to access (14 from FIG. 2 and 37 from FIG. 3) the one or more networks (4), the user-interface of the website or other portal (3) prompts the user to create (18 in FIG. 2 and 38 in FIG. 3) a password-protected account and/or profile. If the user chooses not to create (20 in FIG. 2 and 39 in FIG. 3) a password-protected account and/or profile, the user is preferably denied access (21 in FIG. 2 and 40 in FIG. 3) to the portal. As shown in FIG. 2, with respect to a local organization (7) that has been previously certified and as a result, already has its own unique username and password, the certified local organization accesses the portal by entering its username and password (10). As described more fully below, each of these local organizations (7) are taught, trained, supported and certified to use the method and system by a managing organization (6). Once the certified local organization enters its own username and password, the user-interface (8) of the website or other portal (3) gives the certified local organization the opportunity to create an account and/or profile for a recipient (2) that is associated with the certified local organization. If the certified local organization wishes to create a recipient account/profile (19), it can input biographical information (15) about the individual recipient into the system using the user-interface (8). This biographical information may include, but is not limited to, a picture (16) of the recipient and the recipient's name, date of birth, address, telephone number, and the most likely common place to find the recipient. The system or method will be sophisticated and advanced enough to use face and/or hand recognition capabilities and/or other similar technologies to make sure that an individual recipient is not entered more than once into the entire database of the system. The biographical information (15 and 16) entered into the system is subsequently stored (17) in a searchable format in the database (5) via the one or more data networks (4), which are in wired or wireless communication with the website or other portal (3). Once the recipient's information is stored, the certified local organization (7) is provided with a unique order confirmation (22). Using this unique order confirmation, the certified local organization (7) may access the portal (23) and can choose to request a donation (24) on behalf of the recipient (2) by entering (25) a written and/or visual description of the type of item or service that the particular recipient would personally like to receive. The certified local organization (7) can also have the discretion to request a specific item or service for the recipient based upon the local organization's knowledge and understanding of the recipient's environment and living condition. Preferably, the recipient or the local organization may be permitted to request more than one item or service (27). If the recipient or the local organization chooses to request more than one item or service (28), the system may be configured to limit (31) the number of items and/or services to an “n” number of items and/or services that may be requested by a single recipient during a specific period of time by determining how many items and/or services have been requested by the single recipient during the requisite time period (29 and 30). The information entered in regards to the recipient is subsequently stored (26) in a searchable format in a database (5) via the one or more data networks (4), which are in wired or wireless communication with the website or other portal (3).

Referring to FIGS. 1 and 3, with respect to a donor (1) who wishes to access (37) the portal (3) in order to donate one or more items and/or services, the donor is preferably required to first enter (41 and 42) a username, a password and an e-mail address in order to create an account or profile. The information entered by the donor is stored (43) in a searchable format in a database (5) via the one or more data networks (4), which are in wired or wireless communication with the website or other portal (3). After specifying a username and a password, the donor is then able to gain access to the website or portal (44) and perform different tasks which include, but are not limited to, performing searches of the recipient information stored in the associated data networks and entering information regarding the donor, the characteristics of the one or more items and/or services that the donor would like to donate and the characteristics of the recipient that the donor wishes to donate the item or service to. In addition to the above required information, the donor can also specify the donor's legal name (45), address (47), date of birth (46), marital status (48), nationality (48), college education (48), current annual income (48), and occupation and a “wish list” of items and/or services (49) that the donor would like to donate in the future if a recipient is found. The information entered by the donor is stored (50) in a searchable format in a database (5) via the one or more data networks (4), which are in communication with the website or other portal. In order to protect the donor's anonymity, the donor may choose (52) to keep the information related to the donor's identity anonymous from other donors and recipients (51) such that the information remains hidden from view (54). If the donor does not choose to keep information related to the donor's identity anonymous (53), the information will be visible to other donors, recipients or certified local organizations via the portal (55).

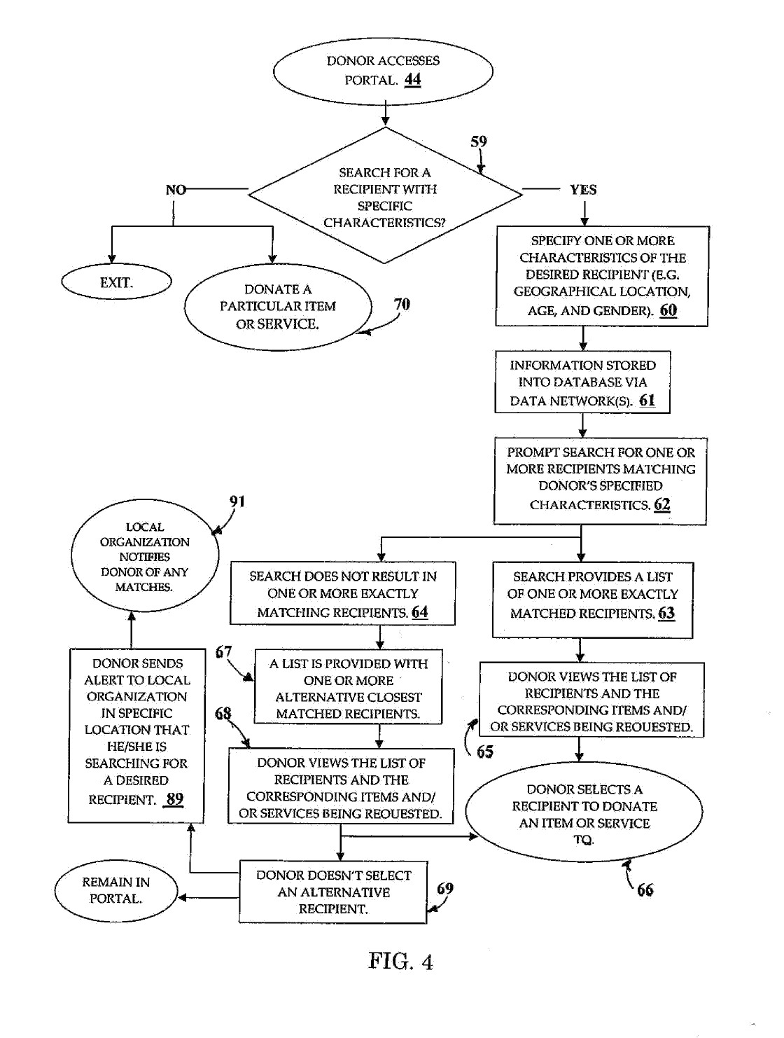

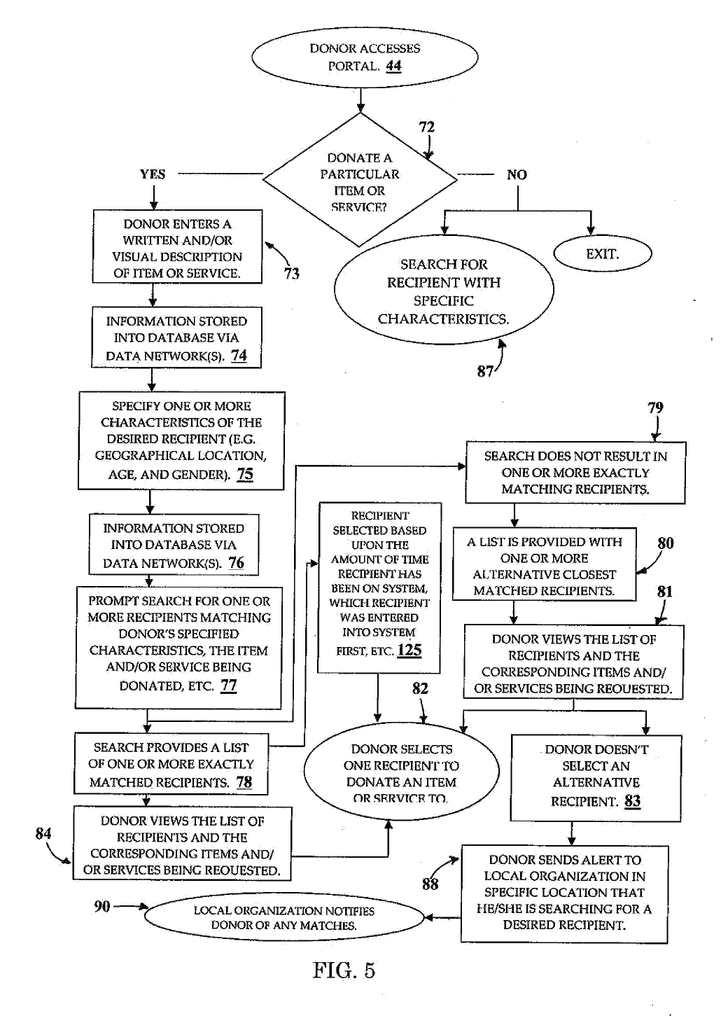

Referring to FIGS. 4 and 5, once the donor has entered the necessary account or profile information and can access the portal (44), the donor can donate a particular item or service (70 in FIG. 4 and 72 in FIG. 5) to a recipient having a set of desired characteristics, or the donor can perform searches of the information stored in the database (5) wherein the searches can be based upon a particular geographical location of a recipient, the types of items or services that are being requested by recipients, and/or the specific characteristics of the recipients (59 in FIG. 4 and 87 in FIG. 5) in order that the donor can determine what types of specific items and/or services are needed (65 and 68).

For example, as shown in FIG. 4, the donor may wish to perform a search (59) to find out what kinds of items or services are needed by a recipient with specific characteristics, for example, the donor may wish to find out what kind of items or services are being requested by a recipient between the ages of 11 and 15 years old and who lives in El Salvador. In order to perform such a search, the donor enters the specific location and age of the desired class of recipients (60) using the user-interface (8). The information entered by the donor is stored (61) in a searchable format in a database (5) via the one or more data networks (4). Thereafter, the donor may prompt (62) the system to perform a search for one or more recipients that match the location and age specified by the donor. Alternatively, the system may automatically perform the search once the donor enters the desired criteria into the system. Once the search is completed, the system generates a list of items and/or services that are needed based on the donor's specified criteria as to the age and location of a desired recipient (63). From the generated list, the donor can view (65) all of the results of the search and select a particular recipient (66) and donate the requested item or service to the selected recipient. In the instance that the system cannot find a recipient that matches the donor's specified criteria (64), the system may provide a list of one or more alternative recipients who most closely match the donor's specified criteria (67). From the generated list, the donor can view (68) all of the results of the search and select a particular recipient (66) and donate the requested item or service to the selected recipient. If the donor is not satisfied by the alternative matches provided by the system (69), the donor may select the option of sending an alert to the local organizations (7) that exist in the geographical location specified by the donor that asks for a potential recipient with the desired characteristics specified by the donor (89). Thereafter, the local organizations can notify the donor once a match has been found (91).

Alternatively, as shown in FIG. 5, the donor may specifically choose to donate a particular item or service (72). Using the user-interface (8), the donor can provide a description of the one or more items and/or services (73). The description of the donated item or service may include, but is not limited to, the appearance, condition and size of the item, the technical specifications and characteristics of the item, the nature of the service, and the appropriate age group of users of the item and/or service. The donor may also upload or provide a pictorial description or image of the one or more items or services. The description provided by the donor is then entered and stored into the one or more data networks in searchable form (74).

For example, the donor may wish to donate his or her used camera. The donor can use the description portion of the user-interface of the website or portal to enter the basic information about the camera, such as the size, model and technical specifications of the camera and the condition of the camera. Once the description of the camera is entered by the donor, the donor can also specify a recipient by the characteristics of the intended recipient including, but not limited to, the age range, gender, and geographical location of the recipient (75). By being able to define the characteristics of the recipient, a donor can choose where and to whom the item or service will be received rather than having no control over the destination of the item or service. For instance, given the example just described, suppose the donor wishes to donate the camera to a male recipient that is between the ages of 16 to 19 and who lives in Bogotá, Colombia. The donor can input these desired characteristics by means of interactive information and/or maps that are displayed on the website or other portal that depicts certain characteristics of the recipients and the geographical locations of all the certified local organizations. Once the donor has selected the characteristics of the desired recipient, the information is stored (76) in a database (5) via the one or more data networks in searchable form so that the system can perform a query, as described below, to determine if there is an exact match for the donated item or service based on the description of the item or service and the given characteristics of the desired recipient.

In order to find one or more recipients who wish to receive the donor's item or service, the donor may select an option that prompts the system to perform a search (77) of the stored recipient data in the one or more data networks in order to find the one or more matches that exist between the item or service that the donor wishes to donate and any recipients. Once the search is completed, the system generates a list of one or more recipients that exactly match the donor's criteria (78). From the generated list, the donor can view (84) all of the results of the search and select a particular recipient (82). The search capabilities of the portal or website will be sophisticated enough to provide close alternatives (80) to the desired item or service or the desired characteristics of the recipient when a direct match does not exist (79). The donor can view (81) all of the alternative results of the search and select a particular recipient (82). At the same time, if there is more than one direct match, the portal or website may select (125) a recipient based upon a number of factors including the donor's desired characteristics, the amount of time the recipients have been waiting for a donation, and the order in which the recipients were entered into the system. If a direct match does not exist, or if the donor is not satisfied by the alternative matches provided by the system (83), the user may select the option of sending an alert (88) to the local organizations that exist in the geographical location specified by the donor that asks for a potential recipient with the desired characteristics specified by the donor. Thereafter, the local organizations can notify the donor once a match has been found (90).

For example, suppose that the system cannot find an exact match whereby a donor in Spain has specified that he or she would like to donate a used tennis racket to a recipient in Costa Rica that is preferably between the ages of 11 and 15 years old. As a result, the system displays the closest matches which are a 14 year-old boy that lives in Guatemala and a 19-year old girl that lives in Costa Rica. At that point the donor may wish to donate the item to one of the two possible recipients or may choose to send an alert to the local organization in Costa Rica letting them know that the donor wishes to donate a used tennis racket to a recipient in Costa Rica that is between 11 and 15 years old. Once the alert is sent, the local organization looks for a possible match and notifies the donor of the possible match once it has found it.

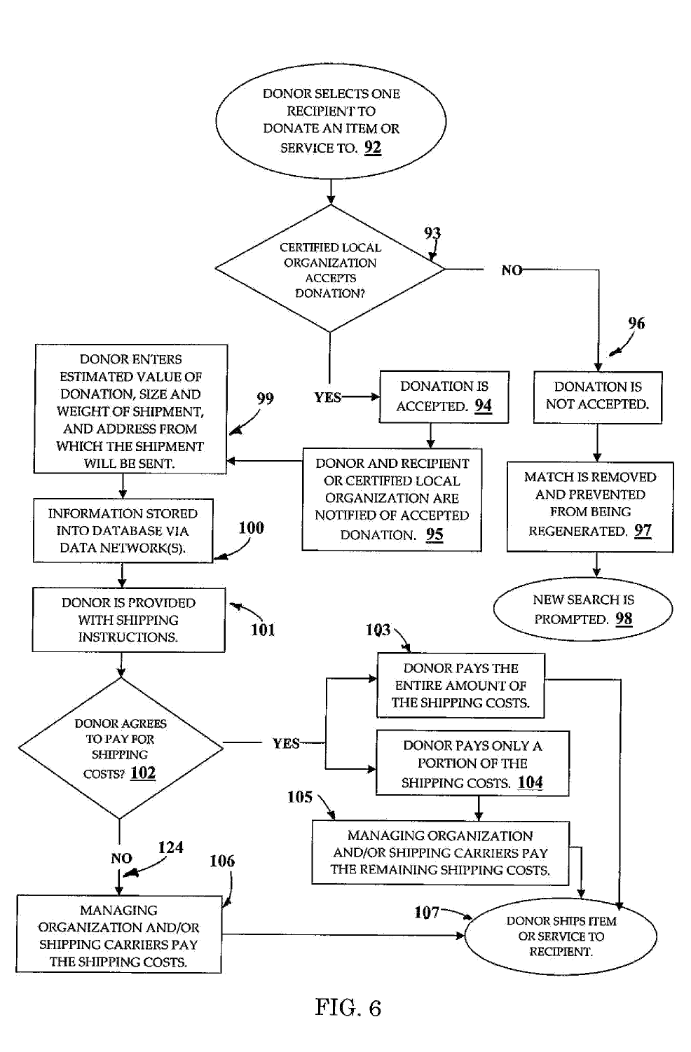

Referring to FIG. 6, once a match is identified by the system and selected by the donor (92), the selected recipient, with the assistance of the local organization, may be required (93) to accept (94) the item or service before it can be shipped accordingly. If, for whatever reason, the recipient that wanted the item or service can no longer be found or no longer wants to receive the item or service, the recipient or local organization can indicate that it does not want to accept the item (96). The system will acknowledge this rejection and will remove that specific match and prevent it from being regenerated (97). At that time, the system may perform a new search in order to identify a new match (98). The system may then provide the donor with the one or more new matches whereby the donor can decide whether he or she still wishes to donate the item or service based on this new set of matches.

At different times during the login session and once the donor has identified a recipient and is ready to donate the item or service, the donor is asked to specify whether he or she wishes to donate the item or service anonymously or with the username, a fictitious name or their legal name. The donor may also be required to provide an estimated value of the item being donated, the size of the shipment container, an estimated weight of the shipment container and a location from which the shipment will be sent (99).

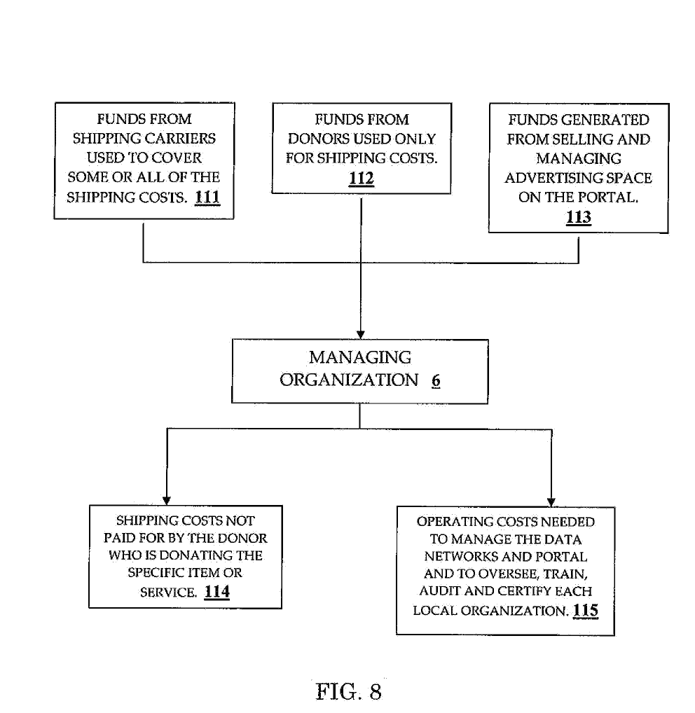

As mentioned above, the method and system may require that the match be accepted by both the donor and the recipient before a notification of the donation is sent to the donor and the local organization in the form of an e-mail or other type of correspondence (95). Thereafter, the user may be asked to specify the geographical location and street address of where the donated item can be picked up for shipment (99). This information is stored into the database via the one or more data networks (100). The donor is then provided (101) with a set of instructions for arranging for and shipping the donated item or service to the intended recipient. Thereafter, the donor may be asked (102) to specify whether he or she wishes to pay for all (103) or a portion (104) of the shipping costs associated with the item or service. If the donor elects to pay for all or some of the shipping costs, the donor must provide a form of payment, such as a credit card number. As depicted in FIG. 6, in the event that the donor does not choose to pay for the entire shipping costs (104 and 124), the remaining shipping costs will be paid for (105 and 106) by the managing organization, using revenue generated by the method and system of the present invention as described below in more detail and in reference to FIG. 8. Alternatively, or in conjunction, it is envisioned that partnerships will be formed with one or more well-known shipping carriers whereby the shipping carriers will agree to pay for some or all of the costs of shipping or provide discounts in their rates in return for shipping volume, free advertising or charitable tax deductions.

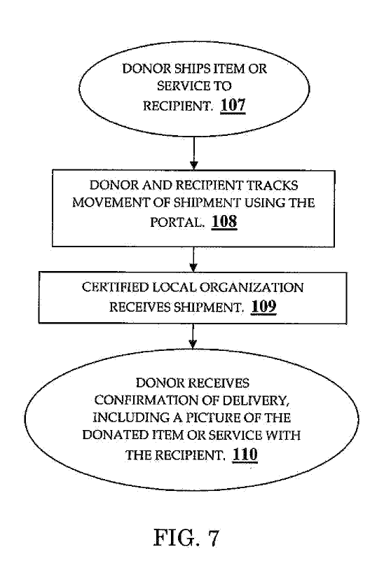

As shown in FIG. 7, the donor arranges for and ships (107) the donated item or service to the intended recipient. The website or portal may provide both the donor and the recipient with the ability to track the movement of the shipped item or service from the moment it leaves the donor until the moment it is received by the intended recipient (108). The movement of the package will be tracked with the tracking resources that are well-known in the art. Once the recipient (2) or certified local organization (7) receives the shipment (109), the donor will receive, if the donor chooses, a picture of the recipient with the donated item or service (110). This picture, along with a confirmation receipt will be uploaded into the portal or website such that if the donor wishes to receive confirmation of the donation, the donor will receive an e-mail or other form of correspondence with the picture and the confirmation receipt.

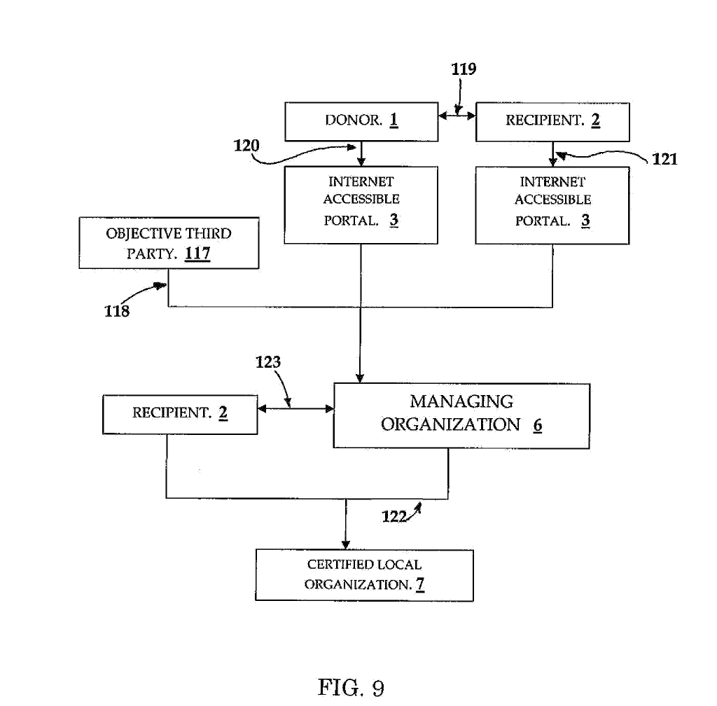

As depicted in FIG. 9, the relevant aspects (e.g. revenues generated and operating costs incurred) of the method and system of the present invention, including those aspects associated with the organization (6) managing this system and the local certified organizations (7) utilizing the disclosed method and system, will preferably be available (120 and 121) thru the portal or website (3) to the users and recipients (1 and 2) in an open and transparent fashion in order to ensure that the donation reaches the donor's target recipient and does not in any way benefit any other person or organization. The organization (6) managing the disclosed method and system and the local certified organizations (7) utilizing the method and system will preferably be audited (118) by an objective outside party (117). The audited information will be available thru the portal or website to the users using standard reporting practices that are typically used by publicly traded companies and non-profit organizations. Further, the organization (6) managing this system will preferably oversee, train, audit and certify (122) each local organization (7) in order that the disclosed method and system is used properly. As a part of the auditing process, the method and system could provide a means of communication (123 and 119) between the actual, individual recipients (2) and the organization (6) managing the system and/or the actual, individual donors (3). As a result, the existence of the recipient and the quality of the recipient's experience with the local organization and the donated item or service can be verified.

Referring to FIG. 8, the main source of revenue generated will preferably be through pay-per-click and banner advertising and other revenue generating methods known to those skilled in the art, via the portal or website (113). This generated revenue will preferably be used to operate (115) the managing organization (6), and to provide costs of shipping (114) where needed. In addition to donating items and services, donors can also donate funds to help support the shipping costs of the other items and services (112) that are being donated by another donor who has elected to not pay for the entire shipping costs.

In addition to the auditing and quality control responsibilities of the associated organization, the associated organization will also work with all the local organizations that assist the individual recipients with utilizing the method and system of the present invention in order that they are properly instructed on how to use the website or other portal and correctly understand and implement the corresponding policies.

In the foregoing description, the present invention has been described with reference to specific exemplary embodiments thereof. It will be apparent to those skilled in the art that a person understanding of this invention may conceive of changes or other embodiments or variations, which utilize the principles of this invention without departing from the broader scope and spirit of the invention. The description and drawings are, therefore, to be regarded in an illustrative rather than a restrictive sense. Accordingly, it is not intended that the invention be limited except as may be necessary in view of the appended claims.

I claim:

1. A method of facilitating global donation, comprising:
inputting into a portal a description of one or more items or services that a recipient wishes to receive;
inputting into said portal a description of the characteristics of the recipient;
inputting into said portal a description of one or more items or services that a donor wishes to donate;
inputting into said portal a description of the characteristics of a desired recipient that the donor wishes to donate said one or more items or services to;
storing each of said descriptions in at least one database that is in communication with said portal; and
performing a search of the at least one database to determine whether any matches exist between said donor and at least one recipient based upon a match between the donor's description of the item or service that is being donated, the desired characteristics of the recipient that the donor wishes to donate to, the recipient's description of the item or service that it wishes to receive and the characteristics of the recipient.

2. The method of claim 1 wherein said portal is Internet-accessible.

3. The method of claim 1 wherein access to said portal requires a password.

4. The method of claim 1 wherein an organization that is local to and associated with the recipient inputs into said portal the description of the one or more items or services that the recipient wishes to receive and the characteristics of the recipient.

5. The method of claim 4 wherein a managing organization teaches, trains, supports, certifies and audits each local organization in order to ensure that each local organization is properly utilizing the method.

6. The method of claim 1 wherein the description of the one or more items or services is comprised of a written description, a visual image, a visual or audio media clip, or a combination thereof.

7. The method of claim 1 wherein the characteristics of the desired recipient and the actual recipient include the recipient's age, gender and geographical location.

8. The method of claim 1 wherein the donor is provided with all matches resulting from the search or the donor is provided with one or more alternative matches wherein the search did not result in a direct match between the donor and a recipient.

9. The method of claim 8 wherein the recipient who was entered into the at least one database first is selected to receive the item or service wherein the search resulted in more than one direct match between the donor and a recipient.

10. The method of claim 8 wherein the donor selects the recipient who will receive the item or service from the one or more matches.

11. The method of claim 8 wherein the donor can alert a local organization of the donor's description of the one or more items or services that a donor wishes to donate and the characteristics of a desired recipient wherein the search did not result in a direct match between the donor and a recipient.

12. The method of claim 10 wherein the donor ships the item or service to the recipient based upon a set of instructions provided to the donor on said portal.

13. The method of claim 12 wherein the donor is given the option of paying all or a portion of the costs associated with shipping the item or service to the recipient.

14. The method of claim 13 wherein a portion or all of the costs associated with shipping the item or service are paid for by the managing organization wherein the donor chooses not to pay for the costs.

15. The method of claim 14 wherein a portion or all of the costs associated with shipping the item or service are paid for by shipping carriers in partnership with the managing organization wherein the donor chooses not to pay for the costs.

16. The method of claim 12 wherein the donor is provided with a confirmation of receipt once the item or service is received by the recipient.

17. The method of claim 16 wherein the confirmation of receipt is comprised of a photograph depicting the recipient with the donated item or service.

18. The method of claim 12 wherein the donor can track the movement of the shipped item or service from the donor's location to the recipient's location.

19. The method of claim 1 wherein advertising space is sold on said portal as a source of revenue.

20. The method of claim 5 wherein the financial information of the managing organization is accessible by the donor using the portal.

21. A method of facilitating global donation, comprising:
inputting into a portal a description of one or more items or services that a recipient wishes to receive;
inputting into said portal a description of the characteristics of the recipient;
inputting into said portal a description of the characteristics of a desired recipient that the donor wishes to donate one or more items or services to;
storing each of said descriptions in at least one database that is in communication with said portal;
generating at least one recipient whose characteristics match the donor's description of the characteristics of a desired recipient; and
donating to the at least one recipient one or more items or services that have been requested by the recipient.

22. The method of claim 21 wherein said portal is Internet-accessible.

23. The method of claim 21 wherein access to said portal requires a password.

24. The method of claim 21 wherein an organization that is local to and associated with the recipient inputs into said portal the description of the one or more items or services that the recipient wishes to receive and the characteristics of the recipient.

25. The method of claim 24 wherein a managing organization teaches, trains, supports, certifies and audits each local organization in order to ensure that each local organization is properly utilizing the method.

26. The method of claim 21 wherein the description of the one or more items or services is comprised of a written description, a visual image, a visual or audio media clip, or a combination thereof.

27. The method of claim 21 wherein the characteristics of the desired recipient and the actual recipient include the recipient's age, gender and geographical location.

28. The method of claim 21 wherein the donor ships the item or service to the recipient based upon a set of instructions provided to the donor on said portal.

29. The method of claim 28 wherein the donor is given the option of paying all or a portion of the costs associated with shipping the item or service to the recipient.

30. The method of claim 29 wherein a portion or all of the costs associated with shipping the item or service are paid for by the managing organization wherein the donor chooses not to pay for the costs.

31. The method of claim 30 wherein a portion or all of the costs associated with shipping the item or service are paid for by shipping carriers in partnership with the managing organization wherein the donor chooses not to pay for the costs.

32. The method of claim 28 wherein the donor is provided with a confirmation of receipt once the item or service is received by the recipient.

33. The method of claim 32 wherein the confirmation of receipt is comprised of a photograph depicting the recipient with the donated item or service.

34. The method of claim 28 wherein the donor can track the movement of the shipped item or service from the donor's location to the recipient's location.

35. The method of claim 21 wherein advertising space is sold on said portal as a source of revenue.

36. The method of claim 25 wherein the financial information of the managing organization is accessible by the donor using the portal.

37. A method of facilitating global donation, comprising:
creating a password-protected profile of a recipient on an Internet-accessible portal;
inputting into a portal a description of one or more items or services that the recipient wishes to receive;
inputting into said portal a description of the characteristics of the recipient; creating a password-protected profile of a donor on an Internet-accessible portal;
inputting into said portal a description of one or more items or services that the donor wishes to donate;
inputting into said portal a description of the characteristics of a desired recipient that the donor wishes to donate said one or more items or services to;
storing each of said descriptions in at least one database that is in communication with said portal;
providing the donor with all matches resulting from a search of the at least one database between said donor and at least one recipient based upon a match between the donor's description of the item or service that is being donated, the desired characteristics of the recipient that the donor wishes to donate to, the recipient's description of the item or service that it wishes to receive and the characteristics of the recipient or providing the donor with one or more alternative matches wherein the search did not result in a direct match between the donor and a recipient;
wherein the donor selects the recipient who will receive the item or service from the matches and ships the item or service to the recipient based upon a set of instructions provided to the donor on said portal; and
wherein the donor is provided with a confirmation of receipt once the item or service is received by the recipient that is comprised of a photograph depicting the recipient with the donated item or service

38. The method of claim 37 wherein an organization that is local to and associated with the recipient inputs into said portal the description of the one or more items or services that the recipient wishes to receive and the characteristics of the recipient.

39. The method of claim 38 wherein a managing organization teaches, trains, supports, certifies and audits each local organization in order to ensure that each local organization is properly utilizing the method.

40. The method of claim 37 wherein the description of the one or more items or services is comprised of a written description, a visual image, a visual or audio media clip, or a combination thereof.

41. The method of claim 37 wherein the characteristics of the desired recipient and the actual recipient include the recipient's age, gender and geographical location.

42. The method of claim 37 wherein the recipient who was entered into the at least one database first is selected to receive the item or service wherein the search resulted in more than one direct match between the donor and a recipient.

43. The method of claim 37 wherein the donor can alert a local organization of the donor's description of the one or more items or services that a donor wishes to donate and the characteristics of a desired recipient wherein the search did not result in a direct match between the donor and a recipient.

44. The method of claim 37 wherein the donor is given the option of paying all or a portion of the costs associated with shipping the item or service to the recipient.

45. The method of claim 44 wherein a portion or all of the costs associated with shipping the item or service are paid for by the managing organization wherein the donor chooses not to pay for the costs.

46. The method of claim 45 wherein a portion or all of the costs associated with shipping the item or service are paid for by shipping carriers in partnership with the managing organization wherein the donor chooses not to pay for the costs.

47. The method of claim 37 wherein the donor can track the movement of the shipped item or service from the donor's location to the recipient's location.

48. The method of claim 37 wherein advertising space is sold on said portal as a source of revenue.

49. The method of claim 39 wherein the financial information of the managing organization is accessible by the donor using the portal.

50. The method of claim 37 wherein the recipient or the local organization must accept the item or service before the donor ships the item or service to the recipient.

51. The method of claim 50 wherein the match between the donor and the recipient is removed from the available matches and a new search of the at least one database are performed wherein the recipient does not accept the item or service.

52. The method of claim 37 wherein means are provided for the donor and the recipient to directly communicate.

53. The method of claim 38 wherein means are provided for the donor and the local organization to directly communicate.

54. The method of claim 39 wherein means are provided for the managing organization and the recipient to directly communicate.

55. A system for facilitating global donation, comprising:
an Internet-accessible portal;
a recipient wherein the recipient's description of one or more items or services that the recipient wishes to receive and a description of the characteristics of the recipient is input into said portal;
a donor wherein the donor inputs into said portal a description of one or more items or services that the donor wishes to donate and a description of the characteristics of a desired recipient that the donor wishes to donate said one or more items or services to;
at least one database in communication with said portal wherein each of said descriptions is stored such that the at least one database is searched for any matches between said donor and at least one recipient based upon a match between the donor's description of the item or service that is being donated, the desired characteristics of the recipient that the donor wishes to donate to, the recipient's description of the item or service that it wishes to receive and the characteristics of the recipient.

56. The system of claim 55 wherein access to said portal requires a password.

57. The system of claim 55 wherein an organization that is local to and associated with the recipient inputs into said portal the description of the one or more items or services that the recipient wishes to receive and the characteristics of the recipient.

58. The system of claim 57 a managing organization teaches, trains, supports, certifies and audits each local organization in order to ensure that each local organization is properly utilizing the method.

59. The system of claim 55 wherein the description of the one or more items or services is comprised of a written description, a visual image, a visual or audio media clip, or a combination thereof.

60. The system of claim 55 wherein the characteristics of the desired recipient and the actual recipient include the recipient's age, gender and geographical location.

61. The system of claim 55 wherein the donor is provided with all matches resulting from the search or the donor is provided with one or more alternative matches wherein the search did not result in a direct match between the donor and a recipient.

61. The system of claim 60 wherein the recipient who was entered into the at least one database first is selected to receive the item or service wherein the search resulted in more than one direct match between the donor and a recipient.

62. The system of claim 60 wherein the donor selects the recipient who will receive the item or service from the one or more matches.

63. The system of claim 60 wherein the donor can alert a local organization of the donor's description of the one or more items or services that a donor wishes to donate and the characteristics of a desired recipient wherein the search did not result in a direct match between the donor and a recipient.

64. The system of claim 62 wherein the donor ships the item or service to the recipient based upon a set of instructions provided to the donor on said portal.

65. The system of claim 64 wherein the donor is given the option of paying all or a portion of the costs associated with shipping the item or service to the recipient.

66. The system of claim 65 wherein a portion or all of the costs associated with shipping the item or service are paid for by the managing organization wherein the donor chooses not to pay for the costs.

67. The system of claim 66 wherein a portion or all of the costs associated with shipping the item or service are paid for by shipping carriers in partnership with the managing organization wherein the donor chooses not to pay for the costs.

68. The system of claim 64 wherein the donor is provided with a confirmation of receipt once the item or service is received by the recipient.

69. The system of claim 68 wherein the confirmation of receipt is comprised of a photograph depicting the recipient with the donated item or service.

70. The system of claim 64 wherein the donor can track the movement of the shipped item or service from the donor's location to the recipient's location.

71. The system of claim 55 wherein advertising space is sold on said portal as a source of revenue.

72. The system of claim 58 wherein the financial information of the managing organization is accessible by the donor using the portal.
